(19) United States
(12) Patent Application Publication
(10) Pub. No.: US 2025/0307700 A1
(43) Pub. Date: Oct. 2, 2025

(54) DATA LABELING USING A PREVALENCE-DRIVEN ARTIFICIAL INTELLIGENCE MODEL

(71) Applicant: CrowdStrike, Inc., Sunnyvale, CA (US)

(72) Inventors: Mihai Nechita, Iasi (RO); Mihai Maganu, Stuttgart (DE); Filip Munteanu, Bucharest (RO); Daniel Chipiristeanu, Bucharest (RO)

(21) Appl. No.: 18/624,424

(22) Filed: Apr. 2, 2024

(51) Int. Cl. G06N 20/00

(52) U.S. Cl. CPC G06N 20/00

(57) ABSTRACT

The present disclosure provides an approach of receiving a hash corresponding to a sample file, and providing the hash to an artificial intelligence (AI) model. The AI model is trained to utilize prevalence data corresponding to the hash to predict whether the corresponding sample file includes malware. The approach produces, by a processing device using the AI model, a confidence level based on the hash. In turn, the approach associates a label to the sample file based on the confidence level to produce a labeled sample file.

### TECHNICAL FIELD

Aspects of the present disclosure relate to the field of machine learning and cybersecurity, and more particularly, to an approach for accurately labeling files using a prevalence-driven artificial intelligence (AI) model.

### BACKGROUND

Malicious files are files that include harmful code designed to compromise, damage, or disrupt a computer system or network. Malware, ransomware, spyware, and viruses all fall under the umbrella of malicious files, each with their destructive capabilities. The identification and detection of malicious files are essential to maintaining the integrity and security of computer systems. Various approaches have been employed to detect these harmful files. Traditional methods rely on antivirus software using signature-based detection, which compares a file to a library of known threats.

In recent years, machine learning models have been designed to distinguish malicious files from benign files. Machine learning model detection mechanisms leverage mathematical models and algorithms to identify patterns and correlations in data, facilitating the automated prediction or classification of future instances based on these learned patterns. In the context of cybersecurity, these mechanisms are adept at differentiating between malicious activities and benign activities, thereby improving threat detection and mitigation by learning from patterns inherent in both historical and real-time data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for utilizing prevalence data to associate labels to sample files, in accordance with some embodiments of the present disclosure.

FIG. 2 is a diagram that illustrates an example system for generating a feature vector based on prevalence data, in accordance with some embodiments of the present disclosure.

FIG. 3 is a flow diagram of a method for associating a label to a sample file based on a label rule and a confidence level, in accordance with some embodiments of the present disclosure.

FIG. 4 is a flow diagram of a method for associating a label to a sample file based on prevalence data, in accordance with some embodiments of the present disclosure.

FIG. 5 is a block diagram that illustrates an example system for associating a label to a sample file based on prevalence data, in accordance with some embodiments of the present disclosure.

FIG. 6 is a block diagram of an example computing device that may perform one or more of the operations described herein, in accordance with some embodiments of the present disclosure.

### DETAILED DESCRIPTION

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. As discussed herein, artificial intelligence models, or AI models, include machine learning models, large language models, and other types of models that are based on neural networks, genetic algorithms, expert systems, Bayesian networks, reinforcement learning, decision trees, or combination thereof.

Machine learning model detection mechanisms (referred to herein as AI-driven malware detectors) are trained on sample files that are labeled as clean (no malware), dirty (includes malware), or no label (undetermined). The AI-driven malware detectors may produce false positives based on inaccurate training data (e.g., a sample file with no malware is labeled as dirty). A false positive is a benign file that is erroneously classified as containing malware.

Existing approaches to reduce false positives involve manually inspecting the false positive cases, and then adding exception rules to the AI-driven malware detectors that preclude future instances of similar false positives. This manual process typically involves a trained professional with a security background, such as an information technology (IT) administrator, security analyst, or security researcher. These professionals are tasked with investigating the false positive event and determining whether the event represents a legitimate case of malicious behavior or simply a false positive. Upon making this determination, the trained professional then manually creates and adds an exception rule to the AI-driven malware detector to prevent future false positives of the same nature.

A challenge found with current solutions is that this approach is labor-intensive and requires a considerable investment of time and resources, requiring trained professionals to devote significant effort to the discovery and analysis of events and the decision-making process regarding their nature. Another challenge found is the limitation of resources. The resources available for managing false positives are finite, with the number of individuals capable of investigating logging traces and events being particularly limited. As such, the process of manually labeling samples is typically overwhelming and intractable due to, for example, hundreds of thousands of files being ingested on a daily basis. This challenge is further compounded by the diverse technologies, contexts, and workflows in which false positives can occur, making the problem exponentially more difficult to solve. In addition, customer environments can introduce highly variable elements to be considered when a trained professional attempts to address the problem more generically. Given that false positives are often tied to a particular AI-driven malware detector, a tailored solution is required for the particular combination of the AI-driven malware detector, customer environment, and event that triggered the false positive.

The present disclosure addresses the above-noted and other deficiencies by using prevalence data to increase the accuracy of labeling training data that is utilized to train AI-driven malware detectors. The present disclosure uses a processing device to receive a hash that corresponds to a sample file ingested from an external data source. The processing device provides the hash to an artificial intelligence (AI) model, which is trained to utilize prevalence data corresponding to the hash to predict whether the sample file includes malware. The prevalence data includes, for example, metadata pertaining to the occurrence or frequency of file types, file names, file properties, or a combination thereof. In some embodiments, the prevalence data is collected from various customer systems. The processing device uses the AI model to produce a confidence level based on the hash. In turn, the processing device associates a label to the sample file based on the confidence level to produce a labeled sample file. In some embodiments, the processing device associates the label to the sample file by assigning the label to the sample file; assigning the label to the hash; indexing the label and the sample file by the hash; or a combination thereof.

In some embodiments, to determine whether to associate a clean label or a dirty label to the sample file, the processing device analyzes content information, collected during sample file ingestion, against a label rule (e.g., a label dirty rule), which attempts to determine whether the sample file includes malware. The processing device also compares the confidence level to a threshold (e.g., a high confidence threshold that the sample file is clean). When the label dirty rule determines that the sample file includes the malware, and that the confidence level at least meets the threshold, the processing device flags the sample file for further analysis indicating a misalignment between the label dirty rule and the AI model.

In some embodiments, when the label dirty rule determines that the sample file includes the malware, and that the confidence level is below the threshold, the processing device associates a dirty label to the sample file. In some embodiments, when the label dirty rule has no indication of the sample file being malicious, and that the confidence level at least meets the threshold, the processing device associates a clean label to the sample file.

In some embodiments, the processing device generates a feature vector, corresponding to the hash, utilizing prevalence metadata comprising incidence information about the sample file. For example, the prevalence data may include information pertaining to a maximum number of clients that report the sample file, the maximum number of agents (of a client) that report the sample file, the number of clients that reported an event (e.g., when the sample file was executed, loaded into memory, etc.), or a combination thereof. In turn, the AI model utilizes the feature vector to produce the confidence level.

In some embodiments, the sample file is unavailable to the AI model during the producing of the confidence level. In some embodiments, the processing device initiates a training session of an AI-driven malware detector using the labeled sample file to reduce an amount of false positive malware detections by the AI-driven malware detector.

As discussed herein, the present disclosure provides an approach that improves the operation of a computer system by utilizing prevalence data to accurately associate a label to a sample file. In addition, the present disclosure provides an improvement to the technological field of cybersecurity by enhancing the malware detection accuracy of an AI-driven malware detector by providing accurately labeled sample files for training purposes, which reduces the amount of false positive malware detections by the AI-driven malware detector.

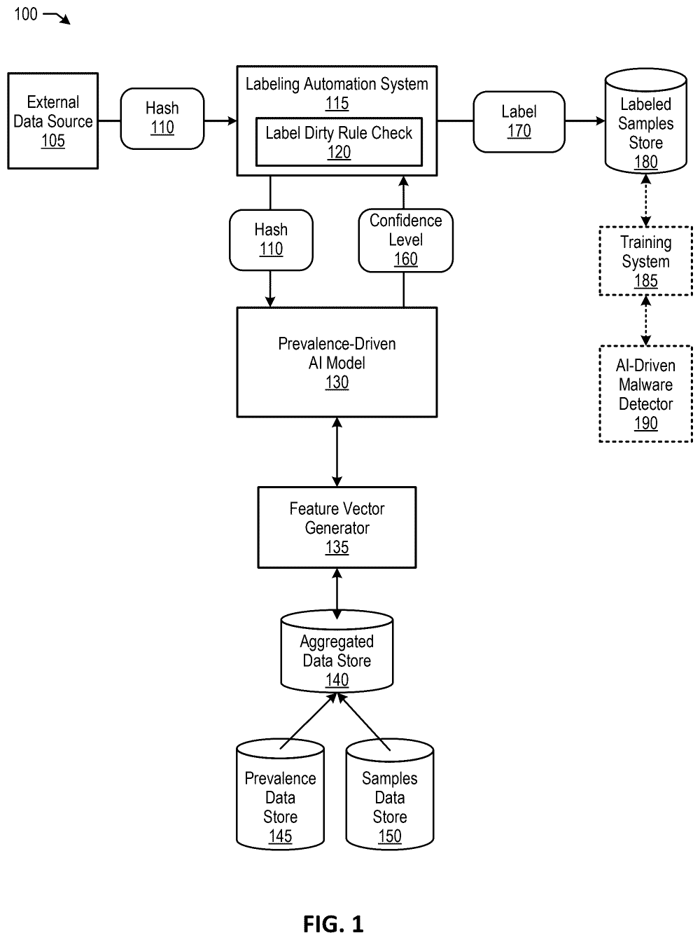

FIG. 1 is a block diagram that illustrates an example system for utilizing prevalence data to associate labels to sample files, in accordance with some embodiments of the present disclosure.

System 100 includes labeling automation system 115. Labeling automation system 115 receives hash 110 (e.g., a hash) from external data source 105. For example, hash 110 may be a hash previously generated from a file ingested on a daily basis from various external Internet sources (e.g., scraping the Internet). Labeling automation system 115 sends hash 110 to prevalence-driven AI model 130. Prevalence-driven AI model 130 has been trained to utilize prevalence data corresponding to the hash to predict whether the sample file includes malware. Prevalence-driven AI model 130 sends a request to feature vector generator 135 that includes hash 110. In some embodiments, the interface between prevalence-driven AI model 130 and feature vector generator 135 is an API (application programming interface).

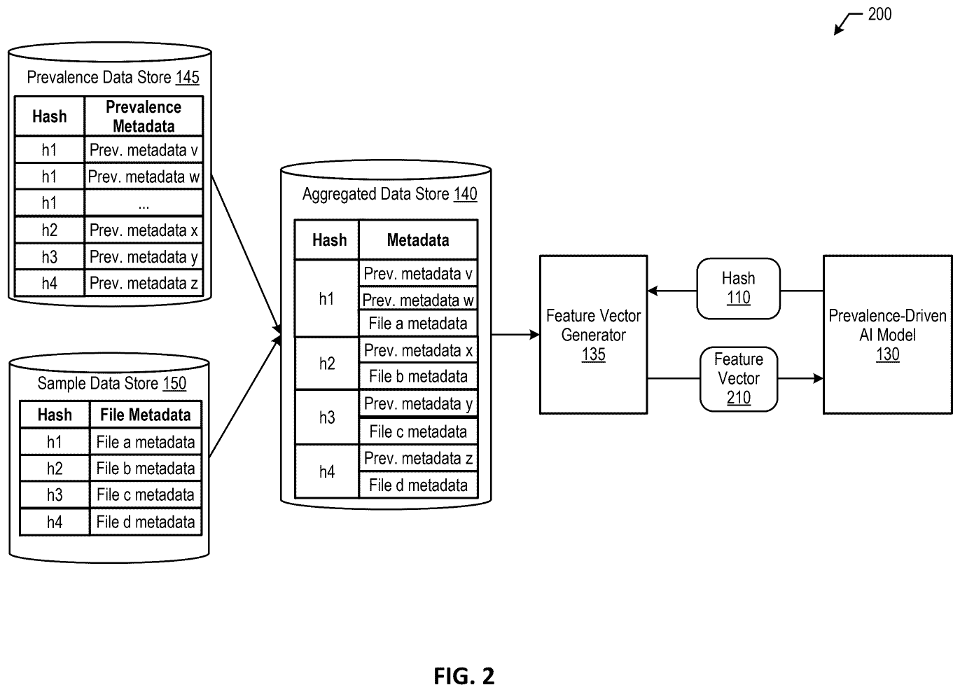

Feature vector generator 135 generates a feature vector for hash 110 based on information included in aggregated data store 140. Aggregated data store 140 is an aggregation of prevalence data store 145 and samples data store 150 that is indexed by hash (see FIG. 2 and corresponding text for further details). The prevalence information (prevalence data) in prevalence data store 145 and the sample metadata information in sample data store 150 may be provided by, for example, sensor agents running on customers machines. In some embodiments, due to limiting factors such as bandwidth and sample size, the sensor agents locally compute a hash (e.g., sha256 hash) of the sample file and send a payload with the hash and the prevalence information or metadata that are stored in prevalence data store 145 and samples data store 150, respectively.

Prevalence data store 145 includes statistical measurement information detailing the occurrence or frequency of file types, file names, or file properties within a given data set, computer system, or network at a particular point in time. For example, prevalence data store 145 may include information pertaining to a maximum number of clients that report the file, the maximum number of agents that report a file (client may have a number of agents), the number of clients that reported an event where file was executed, loaded into memory, how widely spread the file is over multiple clients and how activity level of the file. Samples data store 150 includes meta information about a file, file size, first time the file was evaluated, most recent time the file was evaluated, architecture of the file, operating system for which the file is built, etc. In some embodiments, system 100 performs a daily aggregation that updates aggregated data store 140.

Feature vector generator 135 then provides a feature vector to prevalence-driven AI model 130. In turn, prevalence-driven AI model 130 generates confidence level 160, which corresponds to a level of confidence that the sample file corresponding to hash 110 is clean from malware.

Labeling automation system 115 receives confidence level 160 and compares confidence level 160 with a “clean” threshold (e.g., the confidence level is high that the sample file is clean from malware). Labeling automation system 115 also analyzes content information corresponding to the sample file with label dirty rule check 120. In some embodiments, the content information is captured during the sample file ingestion and indexed according to a corresponding hash.

Label dirty rule check 120 attempts to determine whether the content information indicates that the sample file includes malware. Labeling automation system 115 may also include label clean rule checks. In some embodiments, the rules which associate dirty labels have a higher priority than the rules that associate clean labels.

Labeling automation system 115 uses the results from label dirty rule check 120 and the comparison of confidence level 160 to the threshold to determine how to label hash 110 (dirty, clean, undetermined). When the sample file content information matches the label dirty rule, and when the confidence level is greater than or equal to the clean level threshold, indicating a false positive, labeling automation system 115 flags the sample file for further analysis. When the sample file content information matches the label dirty rule, and when the confidence level is below the threshold, labeling automation system 115 associates a dirty label to the sample file. When the sample file content information does not match the label dirty rule (e.g., each label dirty rule), and when the confidence level is greater than or equal to the threshold, labeling automation system 115 associates a clean label to the sample file.

In turn, labeling automation system 115 produces label 170 and associates label 170 to the sample file in labeled samples store 180. In some embodiments, labeling automation system 115 associates the label to the sample file by assigning the label to the sample file; assigning the label to the hash; indexing the label and the sample file by the hash; or a combination thereof. Then, in some embodiments, training system 185 uses the labeled sample file to train AI-driven malware detector 190.

In some embodiments, labeling automation system 115 receives a subsequent hash that corresponds to a subsequent file that is marked as dirty (e.g., includes malware). Labeling automation system 115 provides the subsequent hash to prevalence-driven AI model 130. Prevalence-driven AI model 130 sends a request to feature vector generator to provide a subsequent feature vector based on the subsequent hash, and then computes a subsequent confidence score using the subsequent feature vector. In turn, labeling automation system 115 determines whether the subsequent file should be labeled as dirty based on the subsequent confidence level.

FIG. 2 is a diagram that illustrates an example system for generating a feature vector based on prevalence data, in accordance with some embodiments of the present disclosure.

Prevalence data store 145 includes prevalence metadata pertaining to the occurrence or frequency of file types, file names, file properties, or a combination thereof, within a given data set, computer system, network, or a combination thereof.

As shown in system 200, the prevalence metadata is indexed by hash (h1, h2, etc.). In some embodiments, system 100 generates the hashes using similar operations discussed above to generate hash 110.

Sample data store 150 includes file meta information about a file, file size, first time the file was evaluated, most recent time the file was evaluated, architecture of the file, operating system for which the file is built, etc. As shown in system 200, the file metadata is also indexed by hash (h1, h2, etc.).

Aggregated data store 140 includes an aggregation of prevalence data store 145 and sample data store 150. As can be seen, aggregated data store 140 indexes the prevalence metadata and the file metadata by hash. For example, hash h1 includes prevalence metadata v and prevalence metadata w from prevalence data store 145, and also includes file a metadata from sample data store 150. When feature vector generator 135 receives hash 110 from prevalence-driven AI model 130, feature vector generator 135 accesses aggregated data store 140 to generate feature vector 210. For example, if hash 110 is h1, feature vector generator 135 retrieves prevalence metadata v, prevalence metadata w, and file a metadata from aggregated data store 140 to generate feature vector 210. In turn, feature vector generator 135 provides feature vector 210 to prevalence-driven AI model 130, which uses feature vector 210 to determine a corresponding confidence level as discussed herein.

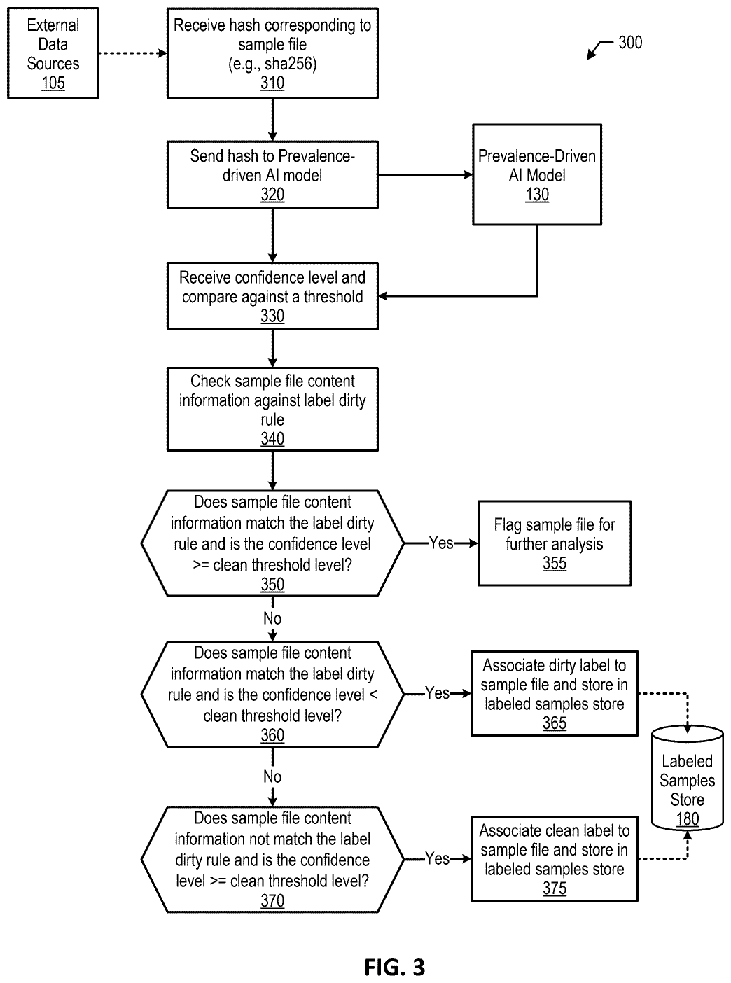

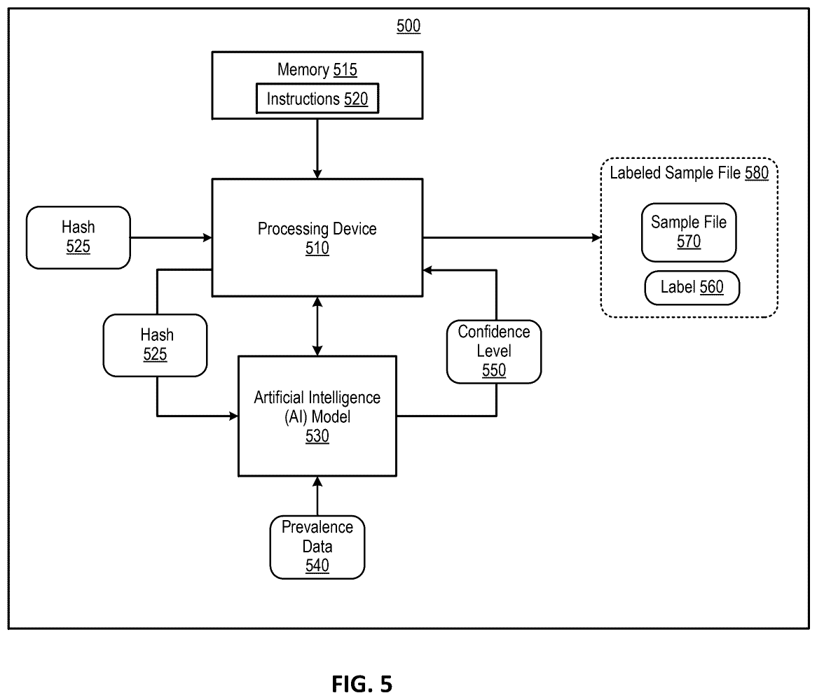

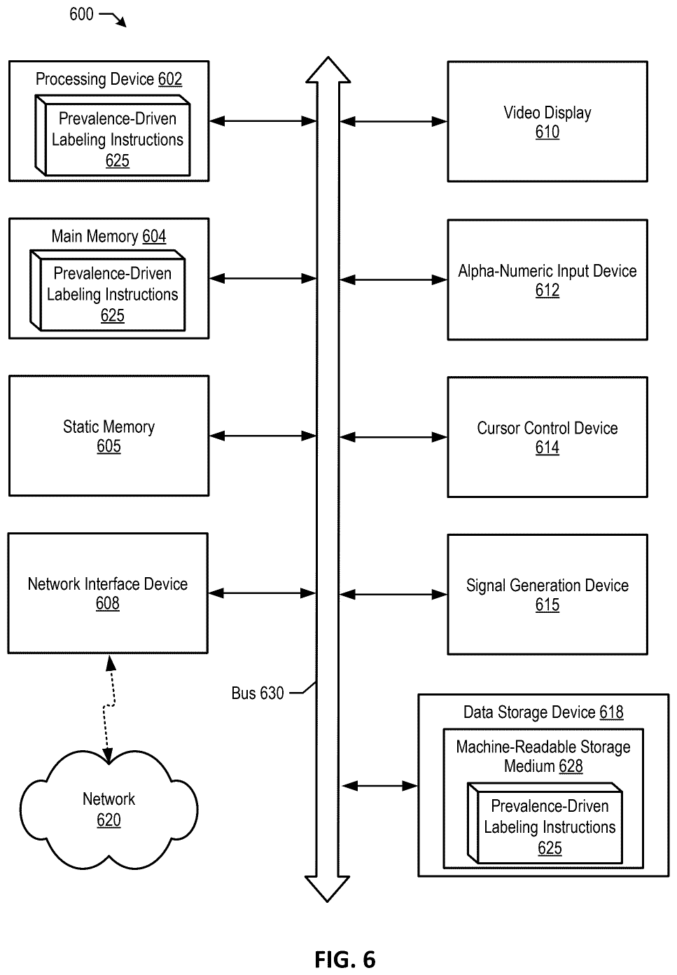

FIG. 3 is a flow diagram of a method 300 for associating a label to a sample file based on a label dirty rule and a confidence level, in accordance with some embodiments of the present disclosure. Method 300 may be performed by processing logic that may include hardware (e.g., a processing device), software (e.g., instructions running/executing on a processing device), firmware (e.g., microcode), or a combination thereof. In some embodiments, at least a portion of method 400 may be performed by labeling automation system 115, prevalence-driven AI model 130, feature vector generator 135, processing device 510 (shown in FIG. 5), processing device 602 (shown in FIG. 6), or a combination thereof.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

With reference to FIG. 3, method 300 begins at block 310, whereupon processing logic receives a hash from external data sources 105, such as one corresponding to a daily ingestion of files from Internet sources (e.g., scraping the Internet). At block 320, processing logic sense the hash to prevalence-driven AI model 130. At block 330, processing logic receives a confidence level from prevalence-driven AI model 130, and compares the confidence level against a threshold as discussed herein.

At block 340, processing logic checks the sample file content information (e.g., captured during file ingestion) against a dirty label rule as discussed herein. At block 350, processing logic determines whether the sample file content information matches the label dirty rule, and also whether the confidence level is greater than or equal to the threshold (indicating a false positive). If this is the case, block 350 branches to block 355, whereupon processing logic flags the sample file for further analysis. Otherwise, block 350 branches to block 360.

At block 360, processing logic determines whether the sample file content information matches the labeled dirty rule, and the confidence level is less than the threshold. This indicates that both the labeled dirty rule and prevalence-driven AI model 130 agree that the sample file is not clean. If this is the case, block 360 branches to block 365, whereupon processing logic associates a dirty label to the sample file in labeled samples store 180. Otherwise, block 360 branches to block 370.

At block 370, processing logic determines whether the sample file does not match the label dirty rule, and that the confidence level is greater than or equal to the threshold. This indicates that both the label dirty rule and the prevalence-driven AI model 130 predict that the sample file is clean. If this is the case, block 370 branches to block 375, whereupon processing logic associates a clean label to the sample file in labeled samples store 180.

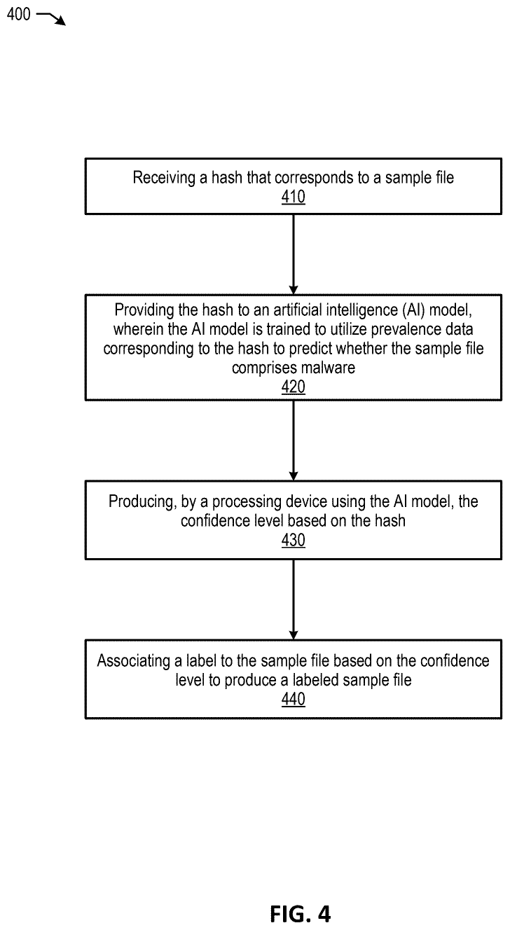

FIG. 4 is a flow diagram of a method 400 for associating a label to a sample file based on prevalence data, in accordance with some embodiments of the present disclosure. Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by labeling automation system 115, prevalence-driven AI model 130, feature vector generator 135, processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic receives a hash that corresponds to a sample file. At block 420, processing logic provides the hash to prevalence-driven AI model 130, which is trained to utilize prevalence data corresponding to the hash to predict whether the sample file comprises malware. At block 430, processing logic uses prevalence-driven AI model 130 to produce a confidence level based on the hash. At block 440, processing logic associates a label to the sample file based on the confidence level to produce a labeled sample file.

FIG. 5 is a block diagram that illustrates an example system for associating a label to a sample file based on prevalence data, in accordance with some embodiments of the present disclosure.

Computer system 500 includes processing device 510 and memory 515. Memory 515 stores instructions 520 that are executed by processing device 510. Instructions 520, when executed by processing device 510, cause processing device 510 to receive hash 525 and provide hash 525 to AI model 530 (e.g., prevalence-driven AI model 130). AI model 530 produces confidence level 550 based on prevalence data 540 (e.g., from prevalence data store 145) that corresponds to hash 525. In turn, processing device 510 associates label 560, which is based on confidence level 550, to sample file 570 to produce labeled sample file 580.

FIG. 6 illustrates a diagrammatic representation of a machine in the example form of a computer system 600 within which a set of instructions, for causing the machine to perform any one or more of the methodologies discussed herein for enhancing automated labeling of sample files.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute prevalence-driven labeling instructions 625, for performing the operations and steps discussed herein.

The data storage device 618 may include a machine-readable storage medium 628, on which is stored one or more sets of prevalence-driven labeling instructions 625 (e.g., software) embodying any one or more of the methodologies of functions described herein. The prevalence-driven labeling instructions 625 may also reside, completely or at least partially, within the main memory 604 or within the processing device 602 during execution thereof by the computer system 600; the main memory 604 and the processing device 602 also constituting machine-readable storage media. The prevalence-driven labeling instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “providing,” “producing,” “associating,” “checking,” “comparing,” “flagging,” “using,” “utilizing,” “initiating,” “receiving,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving a hash that corresponds to a sample file;
providing the hash to an artificial intelligence (AI) model, wherein the AI model is trained to utilize prevalence data corresponding to the hash to predict whether the sample file comprises malware;
producing, by a processing device using the AI model, a confidence level based on the hash; and
associating a label to the sample file based on the confidence level to produce a labeled sample file.

2. The method of claim 1 further comprising:
analyzing content information corresponding to the sample file against a label rule, wherein the label rule determines whether the sample file comprises the malware;
comparing the confidence level to a threshold; and
in response to the label rule determining that the sample file comprises the malware, and that the confidence level at least meets the threshold, flagging the sample file for further analysis.

3. The method of claim 2 further comprising:
in response to the label rule determining that the sample file comprises the malware, and that the confidence level is below the threshold, using a dirty label to associate to the sample file.

4. The method of claim 2 further comprising:
in response to the label rule determining that the sample file is clean from the malware, and that the confidence level at least meets the threshold, using a clean label to associate to the sample file.

5. The method of claim 1, further comprising:
generating, based on the hash, a feature vector utilizing prevalence metadata, wherein the prevalence metadata comprises incidence information about the sample file; and
utilizing, by the AI model, the feature vector during the producing of the confidence level.

6. The method of claim 1, further comprising:
initiating a training of an AI-driven malware detector using the labeled sample file to reduce an amount of false positives of the malware by the AI-driven malware detector.

7. The method of claim 1, further comprising:
receiving a subsequent file that is marked as comprising the malware;
generating a subsequent hash from the subsequent file;
providing the subsequent hash to the AI model;
producing, by the processing device using the AI model, a subsequent confidence level based on the subsequent hash; and
determining whether the subsequent file comprises the malware based on the subsequent confidence level.

8. A system comprising:
a processing device; and
a memory to store instructions that, when executed by the processing device, cause the processing device to:
generate a hash from a sample file;
provide the hash to an artificial intelligence (AI) model, wherein the AI model is trained to utilize prevalence data corresponding to the hash to predict whether the sample file comprises malware;
produce, using the AI model, a confidence level based on the hash; and
associate a label to the sample file based on the confidence level to produce a labeled sample file.

9. The system of claim 8, wherein the processing device is further to:
analyzing content information corresponding to the sample file against a label rule, wherein the label rule determines whether the sample file comprises the malware;
compare the confidence level to a threshold; and
in response to the label rule determining that the sample file comprises the malware, and that the confidence level at least meets the threshold, flag the sample file for further analysis.

10. The system of claim 9, wherein the processing device is further to:
in response to the label rule determining that the sample file comprises the malware, and that the confidence level is below the threshold, use a dirty label to associate to the sample file.

11. The system of claim 9, wherein the processing device is further to:
in response to the label rule determining that the sample file is clean from the malware, and that the confidence level at least meets the threshold, use a clean label to associate to the sample file.

12. The system of claim 8, wherein the processing device is further to:
generate, based on the hash, a feature vector utilizing prevalence metadata, wherein the prevalence metadata comprises incidence information about the sample file; and
utilize, by the AI model, the feature vector during the producing of the confidence level.

13. The system of claim 8, wherein the processing device is further to:
initiate a training of an AI-driven malware detector using the labeled sample file to reduce an amount of false positives of the malware by the AI-driven malware detector.

14. The system of claim 8, wherein the processing device is further to:
receive a subsequent file that is marked as comprising the malware;
generate a subsequent hash from the subsequent file;
provide the subsequent hash to the AI model;
produce, by the processing device using the AI model, a subsequent confidence level based on the subsequent hash; and
determine whether the subsequent file comprises the malware based on the subsequent confidence level.

15. A non-transitory computer readable medium, having instructions stored thereon which, when executed by a processing device, cause the processing device to:
generate a hash from a sample file;
provide the hash to an artificial intelligence (AI) model, wherein the AI model is trained to utilize prevalence data corresponding to the hash to predict whether the sample file comprises malware;
produce, by the processing device using the AI model, a confidence level based on the hash; and
associate a label to the sample file based on the confidence level to produce a labeled sample file.

16. The non-transitory computer readable medium of claim 15, wherein the processing device is to:
analyzing content information corresponding to the sample file against a label rule, wherein the label rule determines whether the sample file comprises the malware;
compare the confidence level to a threshold; and
in response to the label rule determining that the sample file comprises the malware, and that the confidence level at least meets the threshold, flag the sample file for further analysis.

17. The non-transitory computer readable medium of claim 16, wherein the processing device is to:
in response to the label rule determining that the sample file comprises the malware, and that the confidence level is below the threshold, use a dirty label to associate to the sample file.

18. The non-transitory computer readable medium of claim 16, wherein the processing device is to:
in response to the label rule determining that the sample file is clean from the malware, and that the confidence level at least meets the threshold, use a clean label to associate to the sample file.

19. The non-transitory computer readable medium of claim 15, wherein the processing device is to:
generate, based on the hash, a feature vector utilizing prevalence metadata, wherein the prevalence metadata comprises incidence information about the sample file; and
utilize, by the AI model, the feature vector during the producing of the confidence level.

20. The non-transitory computer readable medium of claim 15, wherein the processing device is to:
receive a subsequent file that is marked as comprising the malware;
generate a subsequent hash from the subsequent file;
provide the subsequent hash to the AI model;
produce, by the processing device using the AI model, a subsequent confidence level based on the subsequent hash; and
determine whether the subsequent file comprises the malware based on the subsequent confidence level.
